(19) United States
(12) Patent Application Publication
(10) Pub. No.: US 2008/0201240 A1
(43) Pub. Date: Aug. 21, 2008

(54) Visual shopping graphical user interface

(76) Inventor: Jason Joseph Borden, Santa Clara, CA (US)

Correspondence Address: Jason Joseph Borden, 1004 White Dr., Santa Clara, CA, 95051, US

(21) Appl. No.: 11/706,629

(22) Filed: Feb. 15, 2007

(51) Int. Cl. G06F 17/50

(52) U.S. Cl. 705/27

(57) ABSTRACT

The Visual Shopping Graphical User Interface is a graphical user interface or any type of user interface that allows users to apply any selected product or products to any selected motor vehicle picture in order to view what that product or products would look like on any type of selected motor vehicle.

The visual shopping graphical user interface is my invention for a graphical user interface or any type of user interface that allows users to apply any selected product or products to any selected motor vehicle picture in order to view what the product or products would look like on a selected motor vehicle. Once a user selects a product or products they will be able to view a picture or video file of a selected motor vehicle with any type of product or products made or compatible for that selected vehicle inside and/or out.

One of the main reasons for this invention is that consumers no longer have to purchase any type of product or products for their vehicle blindly. Like for example, rims and a body kit, and realize that they don't look good together. This way they can see for themselves what products they think look best by selecting and applying different products to their selected motor vehicle, rather than visualizing it in their mind. Like for my example listed above another example if I just purchased a BMW M3, already owned a M3, or any other type of motor vehicle, and decide that I want to add a body kit and rims. I could browse through the car menu on the Graphical User Interface and select the year, make, and color of the M3 that I want, and hit apply. Then I could look through the body kit menu for a BMW M3 and apply different ones that I like, and see what looks best on my vehicle. Afterwards, I could look at the rim menu and apply different rims to the picture of my M3, and see what I like. By seeing the body kit, and the rims applied to my M3 separately or together, I would be one hundred percent sure that I will be happy with my purchases, and not be stuck with rims and a body kit that don't look good together and be out a lot of money.

Another large aspect of my invention is that consumers will be able to search through a large variety of different colors and be able to apply the colors to any type of selected motor vehicle and see the outcomes. If they love the color, but after seeing the color applied to their selected vehicle and they decide that it doesn't look the way they thought it would, they can apply a different color. If they find a color that they apply to a selected vehicle, and fall in love with that color, they can print it out, and take it to a body shop. Therefore they can know the outcome, and not be disappointed and out a lot of money

An additional option that is listed, as a dependent claim for claim number one is the option to see the selected product or products applied to any type of motor vehicle in a three-dimensional state. With this option, consumers will be able to view their selected motor vehicle with the selected products from all different angles to make sure that they like the select products that have been applied to their selected vehicle, from all different angles, to be even further sure of their purchases.

1. A graphical user interface that accepts commands to apply any selected product or products to any selected motor vehicle picture and returns applied product or products on the picture of the motor vehicle back to the user.
claim #1 further including—Any type of user interface that accepts commands to apply any selected product or products to any selected motor vehicle picture and returns applied product or products on the picture of the motor vehicle back to the user.
claim #1 further including—Pictures of motor vehicles may be viewed normally or three-dimensional, with or with out applied products.

2. A graphical user interface that allows users to apply any selected product or products to any selected motor vehicle picture and view the outcome on an mpeg or any type of video file.
